(19) United States
(12) Patent Application Publication
(10) Pub. No.: US 2009/0296945 A1
(43) Pub. Date: Dec. 3, 2009

(54) Method and device for evaluating the annoyance of squeaking noises

(76) Inventors: Fawzi Attia, Winnenden (DE); Michael Fischer, Niefern-Oeschelbronn (DE); Winfried Keiper, Tamm (DE); Thomas Zoeller, Gerlingen (DE); Uwe Bretz, Obersulm (DE); Mats Karlsson, Ludwigsburg (DE); Uwe Martin, Ludwigsburg (DE); Michael Raquet, Hemmingen (DE)

Correspondence Address: KENYON & KENYON LLP, ONE BROADWAY, NEW YORK, NY, 10004, US

(21) Appl. No.: 11/991,054

(22) PCT Filed: Jul. 6, 2006
(86) PCT No.: PCT/EP2006/063957

§ 371 Date: Aug. 11, 2009

(30) Foreign Application Priority Data
Aug. 25, 2005 (DE) 10 2005 040 193.7
Nov. 4, 2005 (DE) 10 2005 052 630.6

(51) Int. Cl. H04R 29/00

(52) U.S. Cl. 381/56

(57) ABSTRACT

A method for evaluating the annoyance of squeaking noise within an audible signal generated during operation of a motor vehicle or one of its components. The existence of at least one squeaking noise is detected, this at least one squeaking noise being evaluated with regard to at least two predetermined characteristics, and a variable characterizing the annoyance of this at least one squeaking noise being determined from the at least two evaluations of this at least one squeaking noise.

### FIELD OF THE INVENTION

Noises occurring during operation of a motor vehicle or the components thereof often prove annoying for the driver and the environment and should be detected to the extent possible to then allow noise abatement measures.

### BACKGROUND INFORMATION

German Patent document DE 102 60 723 A1 discusses a method for suppressing switching noises in test triggering of valves and pumps in the hydraulic system of a brake circuit. The triggering is performed over such a short interval of time that there is no mechanical or noise-inducing response of the component being triggered.

### SUMMARY OF THE INVENTION

The exemplary embodiments and/or exemplary methods of the present invention relates to a method for evaluating the annoyance and/or disturbance and/or degree of interference of squeaking noises and/or the annoyance of essentially monotonic noises within a sound signal generated during operation of a motor vehicle or during operation of the components thereof, in which
the existence of at least one squeaking noise is detected
this at least one squeaking noise is evaluated with regard to at least two predetermined features, and
a variable characterizing the annoyance of this at least one squeaking noise is ascertained from the at least two evaluations of this at least one squeaking noise.

Knowledge of an objective variable for the annoyance of squeaking noises makes it possible to make a decision as to whether the squeaking noises are acceptable or whether countermeasures are necessary. To evaluate the annoyance, a variable is ascertained that indicates how severely and/or to what extent the squeaking range is perceived as annoying or unpleasant by the human ear.

An advantageous embodiment of the present invention is characterized in that the squeaking noises are brake squeaking noises. Squeaking brakes have proven to be a significant noise burden for the environment as well as for the driver.

An advantageous embodiment of the present invention is characterized in that
the squeaking noise is detected on the basis of the detection of a maximum in an amplitude spectrum of the sound signal, and
   the at least two features are taken from the list of features, which contains as features
the duration of the squeaking noise,
the maximum level of the weighed amplitude spectrum,
the maximum level of a weighted and smoothed spectrum obtained from the amplitude spectrum by smoothing and weighting,
the specific loudness of the signal,
the product of the duration of the squeaking signal and the maximum level value of the weighted and smoothed spectrum,
the product of the duration of the squeaking signal and the maximum level of the weighted spectrum and
the product of the duration and the specific loudness of the signal.

An advantageous embodiment of the present invention is characterized in that
for each of the at least two features, a single evaluation number is ascertained for the at least one squeaking noise;
the variable characterizing the annoyance of the squeaking noise is ascertained from the at least two ascertained individual evaluation numbers.
   The individual evaluation number indicates for each squeaking noise how essential this squeaking noise is for ascertaining the annoyance for each feature.

An advantageous embodiment of the present invention is characterized in that
the at least one squeaking noise is at least one brake squeaking noise occurring during a single braking operation,
a feature evaluation number is formed for each of the at least two features by linking the individual evaluation numbers ascertained for the respective feature for each brake squeaking noise and
a single annoyance variable characterizing the annoyance of the squeaking noises occurring during the braking operation is ascertained from the at least two ascertained feature evaluation numbers.
   Thus all squeaking events of a braking operation are combined and an objective variable is determined, i.e., the individual annoyance variable for the total annoyance of the squeaking during the braking operation. In particular this takes into account the fact that multiple brake squeaking noises occur during the same braking operation.

An advantageous embodiment of the present invention is characterized in that the linkage is an addition, in particular a weighted addition.

An advantageous embodiment of the present invention is characterized in that
a first intermediate variable is ascertained from the at least two feature evaluation numbers by a weighted addition and
the variable characterizing the annoyance of the squeaking noise is ascertained from the first intermediate variable.

An advantageous embodiment of the present invention is characterized in that the individual annoyance variable is ascertained from the first intermediate variable according to the equation

$$bonisqueal = - \frac{b}{2} - \sqrt{\vert \frac{{b}^{2}}{4} - \frac{c - OV}{a} \vert}$$

where a, b and c are selectable parameters, OV is the first intermediate variable and bonisqueal is the individual annoyance variable.

Three degrees of freedom are available for the most objective and relevant possible method of ascertaining bonisqueal as a result of the selectability of a, b and c.

An advantageous embodiment of the present invention is characterized in that values of a=0.016, b=−23.64375 and c=2.6327 are selected for selectable parameters a, b and c. These values have proven in experiments to be particularly suitable.

An advantageous embodiment of the present invention is characterized in that
the individual annoyance variable is rounded to the next integral value and
the individual annoyance variable is set to a value of 1, if a value of less than 1 is ascertained for the individual annoyance variable, and
the individual annoyance variable is set to a value of 10, if a value greater than 10 is ascertained for the individual annoyance variable.
   Thus the individual annoyance variables are classified in discrete classes.

An advantageous embodiment of the present invention is characterized in that
at least two braking operations are performed,
a total annoyance variable characterizing the annoyance variable of the squeaking noises occurring during the braking operations is ascertained,
the total annoyance variable includes the average of the individual annoyance variables, which fulfill a predetermined condition and are ascertained for each braking operation.
   It is thus possible to ascertain an objective variable for the annoyance of the squeaking noises of a number of braking operations.

An advantageous embodiment of the present invention is characterized in that the predetermined condition involves the particular individual annoyance variable falling below a threshold value, in particular a threshold value of 9.5. This means that extremely minor squeaking noises that are hardly perceptible are not taken into account. With regard to the number 9.5, reference is made to FIG. 1, where numbers are assigned to the annoyance of the squeaking noises.

An advantageous embodiment of the present invention is characterized in that the total annoyance variable also additively includes a term which in turn includes the number of braking operations performed that are subject to squeaking, based on the total number of braking operations, i.e., the percentage of braking operations that are subject to squeaking.

An advantageous embodiment of the present invention is characterized in that this term is ascertained from the number of performed braking operations that are subject to squeaking, based on the total number of braking operations, using a predetermined characteristic curve.

An advantageous embodiment of the present invention is characterized in that the characteristic curve is a monotonically decreasing characteristic curve.

An advantageous embodiment of the present invention is characterized in that
the total annoyance variable is rounded to the next integral value and
the total annoyance variable is set to a value of 1, if a value less than 1 is ascertained for the total annoyance variable, and
the total annoyance variable is set to a value of 10, if a value greater than 10 is ascertained for the total annoyance variable.
   Discrete numbers are thus available for the degree of annoyance.

In addition, the present invention relates to a device including an arrangement for performing the method as described herein.

The advantageous embodiments of the method according to the present invention are also manifested as advantageous embodiments of the device according to the present invention and vice-versa.

### DESCRIPTION OF THE DRAWINGS

FIG. 1 shows an evaluation scale in which the relationship between an evaluation number indicating the annoyance of a squeaking noise and the degree of the annoyance is indicated.

FIG. 2 schematically shows the extraction of features from a squeaking signal.

FIG. 3 shows as an example a correction term on the ordinate. Variable NP, i.e., the ratio of braking operations subject to squeaking and the total number of braking operations in percent, is shown on the abscissa.

FIG. 4 shows the frequency response of various evaluation filters as a function of frequency.

FIG. 5 shows the basic sequence of the method according to the present invention.

### DETAILED DESCRIPTION

The exemplary embodiments and/or exemplary methods of the present invention is based on a method for objective evaluation of the annoyance of squeaking noises caused by brakes in particular. This evaluation is performed using a 10-point scale having discrete increments of 1 through 10, where

1=very unpleasant squeaking,
. . . ,
10=no perceptible squeaking.

The calculated index, also known as “brake objective noise index squeal” or “BONI-squeal,” has a high correlation with human perception based on the perceived annoyance. After extraction of physical and psychoacoustic features from the time signal of a squeaking noise, the evaluation index is formed by combining these features.

Such an index may be used, for example, in application or final acceptance of automotive brakes. Vehicles are frequently operated here by various test drivers on defined test stretches of road, and braking noises, in particular squeaking, are evaluated subjectively. There may be great deviations between evaluations by different drivers and also between evaluations by one and the same driver, although the squeaking signals are physically identical. The exemplary embodiments and/or exemplary methods of the present invention makes it possible to calculate an evaluation index, which corresponds to the average perceived annoyance of the sound, by processing the airborne sound signals that are recorded. This evaluation index permits a reliable and objective statement of the quality of brake noise during the application phase. The high correlation between the evaluation index and the average human perception of annoyance has been demonstrated in extensive listening tests.

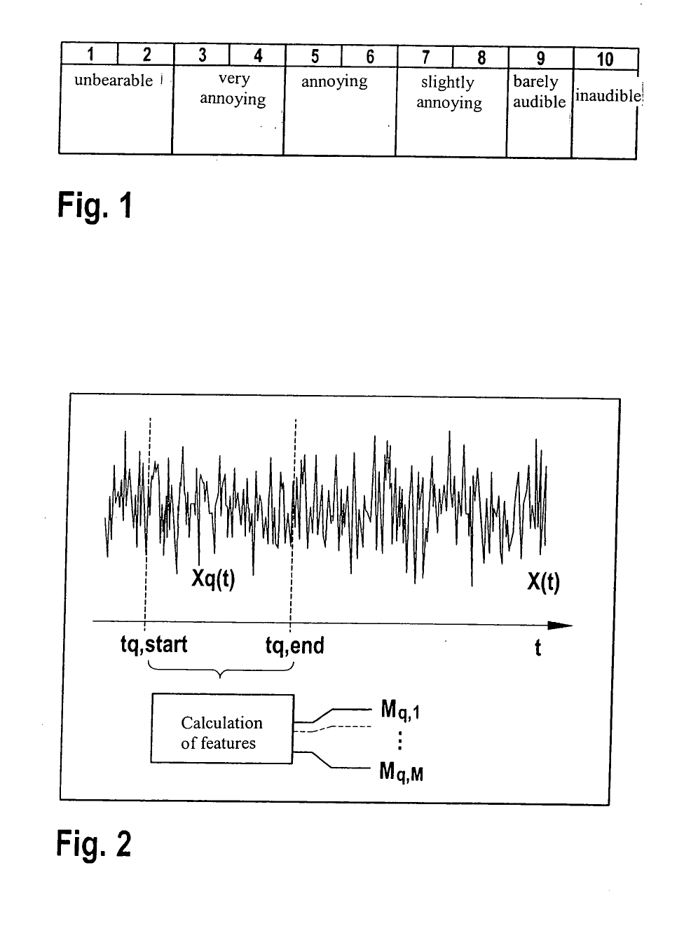

This method yields an evaluation index for the annoyance of squeaking sounds caused by brakes in particular, this index optionally assuming values from 1 to 10 on an ordinal scale. The individual values have the meanings shown in FIG. 1, a higher value indicating a lower annoyance.

Any squeaking noises present in a recorded airborne sound signal x(t) are ascertained. In practice, x(t) may be a microphone signal from the interior of the vehicle, for example. First the squeaking noises in x(t) must be recognized by a suitable method and described according to their frequency-time structure. After analysis of x(t) by such a method, the following variables are available for each detected squeaking signal and/or squeaking event q, where q=1, 2, . . . , Nq:
starting point in time tq,start and the end point in time tq,end of squeaking signal q,
mid-frequency fq of squeaking signal q,
airborne sound level Lq for squeaking signal q.
   Nq is the number of squeaking events. Several squeaking events may occur during a single braking operation.

For each identified squeaking event q, M different features Mqi are calculated for a section xq(t) from signal x(t), where Mqi denotes the value of feature i for squeaking event q.

Such a squeaking event is illustrated in FIG. 2, where an airborne sound signal x(t) is plotted on the ordinate as a function of time t on the abscissa in the upper half of FIG. 2. The existence of a squeaking signal was detected between points in time tq,start and tq,end. Therefore, the signal between these two points in time is labeled as xq(t). During this interval of time, i.e., during the existence of the squeaking event, various features Mqi are calculated for the squeaking signal. Some of these features are obtained by linking features that have already been calculated, e.g., by multiplying them.

For example, features Mq0, . . . , Mq6 are calculated from xq(t):
1) Mq0: Duration of squeaking event q. This duration is labeled as dq and is obtained from dq=tq,end−tq,start
2) Mq1: A-weighted third-octave level Lq(A)
3) Mq2: A-weighted maximum level Lqpeak(A) from peak value spectrum
4) Mq3: specific loudness Ns according to ISO 532 B and DIN 45631
5) Mq4: product of duration and A-weighted third-octave level, i.e., dq*Lq(A)
6) Mq5: product of duration and A-weighted peak value level, i.e., dq*Lqpeak(A)
7) Mq6: product of duration and specific loudness, i.e., dq*Ns

The concept of A-weighting is understood to refer to multiplying a spectrum by the A-weighting curve depicted in FIG. 4. A relative sound pressure level in dB is therefore plotted as a function of frequency in Hz in FIG. 4. The A-weighting curve is labeled as A. This curve takes into account the frequency dependence of the human loudness perception. For example, a low frequency such as 50 Hz is perceptible only above much higher sound pressure levels than a sound at 1000 Hz. When a spectrum is weighted with an A curve, both low and high sounds are attenuated and frequencies around 1000 to 6000 Hz are hardly affected at all. The levels in the A-weighted spectrum at different frequencies are then directly comparable in terms of their loudness perception by humans. An unweighted spectrum containing the two following sounds shall be considered as a concrete example:
sound at 50 Hz having a sound pressure level of 50 dB and
sound at 1000 Hz having a sound pressure level of 20 dB.
   Weighting with an A curve results in:
an attenuation of 30 dB at 50 Hz, yielding an A-weighted level of 20 dB at 50 Hz and
an attenuation of 0 dB at 1000 Hz, yielding an A-weighted level of 20 dB at 1000 Hz.
   Two sounds at a particular A-weighted level of 20 dB are thus perceived as being of equal loudness.

Loudness Ns is another variable describing human loudness perception. Many effects such as the masking of individual sounds by other louder sounds and loudness perception as a function of level are taken into account in this variable, which is standardized in ISO 532 B.

The spectrum of a time signal may be calculated by dividing the time signal into sections of equal duration, one spectrum being calculated for each. The sections may overlap and may also be weighted with a window function before calculation of the spectrum, if necessary, to improve the results. The total spectrum of the signal is then calculated by averaging the individual spectra, namely by averaging all values at the same frequency. In contrast with that, a peak value spectrum is obtained from the aforementioned individual spectra by seeking the maximal value for each frequency in each spectrum and then plotting this accordingly in the resulting peak value spectrum.

For the practical application case of recognizing brake squeaking, a smoothed spectrum is formed by arithmetic averaging of the sound pressure levels of the unsmoothed spectrum in frequency intervals of a one-third octave. The level of this smoothed spectrum, which is also referred to as a one-third octave spectrum, is also referred to as a one-third octave level.

It is possible to obtain the values for these features using an FFT analysis (FFT=Fast Fourier transform). The following settings have proven suitable for FFT analysis: FFT duration=4,096 samples, overlapping of time windows=50%, weighting with Hanning window.

To arrive at an index describing a squeaking event in the further calculations, all features Mqi, i.e., features of type and/or the i-th features for squeaking event q, of squeaking events q occurring simultaneously or overlapping in time are combined from signal x(t). Squeaking events that do not overlap in time and originate from the same braking operation may optionally be included.

This combining is performed by adding all features Mqi of type to form a feature sum, which is standardized using feature-specific factor Ci and thus standardized feature sum FSi

FSi=Ci*Σ_{q}(Mqi).

Ci typically assumes values between 0.01 and 1.

Σ_{q} denotes a summation over all squeaking events q. There is thus a feature sum FSi, i.e., FS0, FS1, . . . , FS6, for each feature of type i, i.e., for Mq0, Mq1, . . . , Mq6. It should be emphasized here that sum FSi may also extend over only one squeaking event, i.e., the feature sum includes only one summand.

All standardized feature sums are then weighted with a feature sum-specific factor Ki and added up, yielding Σᵢ Ki*FSi.

In the exemplary embodiment having features Mq0, Mq1, . . . , Mq6, the summation is over i=0, 1, . . . , 6.

After standardization with Σᵢ Ki, this yields an objective variable OV that represents combined squeaking events q:

OV=Σᵢ(Ki*FSi)/(ρᵢKi).

Insertion of objective variable OV into the equation

$$bonisqueal = - \frac{b}{2} - \sqrt{\vert \frac{{b}^{2}}{4} - \frac{c - OV}{a} \vert} \qquad ( 1 )$$

yields objective evaluation index bonisqueal. Bonisqueal is defined for values of 1 through 10, so that the value calculated on the basis of equation (1)
is set to 1, if equation (1) yields a result lower than 1 and
is set to 10, if equation (1) yields a result greater than 10.
   a, b, and c are selected parameters. Ki typically assumes values between 1 and 10.

For further simplification, it is appropriate in view of the average human evaluation accuracy to round calculated value bonisqueal to integral values.

The following values have proven especially suitable for parameters a, b and c for the method described here:

a=0.016,
b=−23.64375,
c=2.6327.

Variable bonisqueal is the evaluation variable for the annoyance of a single squeaking noise or a series of squeaking noises.

In the practical vehicle test, many braking operations and/or stopping operations are performed and may then be combined to yield a measurement sequence, i.e., a so-called session. The frequency of squeaking events is then determined for a measurement sequence, i.e., session. This frequency of squeaking events is taken into account in the calculation of a measurement sequence evaluation index, i.e., a session evaluation index sessionbonisqueal. For example, all braking operations during a test period and/or test day may be taken into account.

First the arithmetic mean is formed over all unrounded evaluation indices bonisqueal ascertained during the test period or test day having values lower than 9.5. However, only the ascertained squeaking events are included in this average, but braking operations not subject to squeaking are not included.

In addition, the ratio of all braking operations associated with squeaking is ascertained based on the total number of braking operations during the test period or test day. The value ascertained for this ratio in percent is referred to as NP.

Since braking operations not subject to squeaking have not yet been incorporated into the method of ascertaining the arithmetic mean, a correction term referred to as CORRECTION is ascertained below and added to the arithmetic mean.

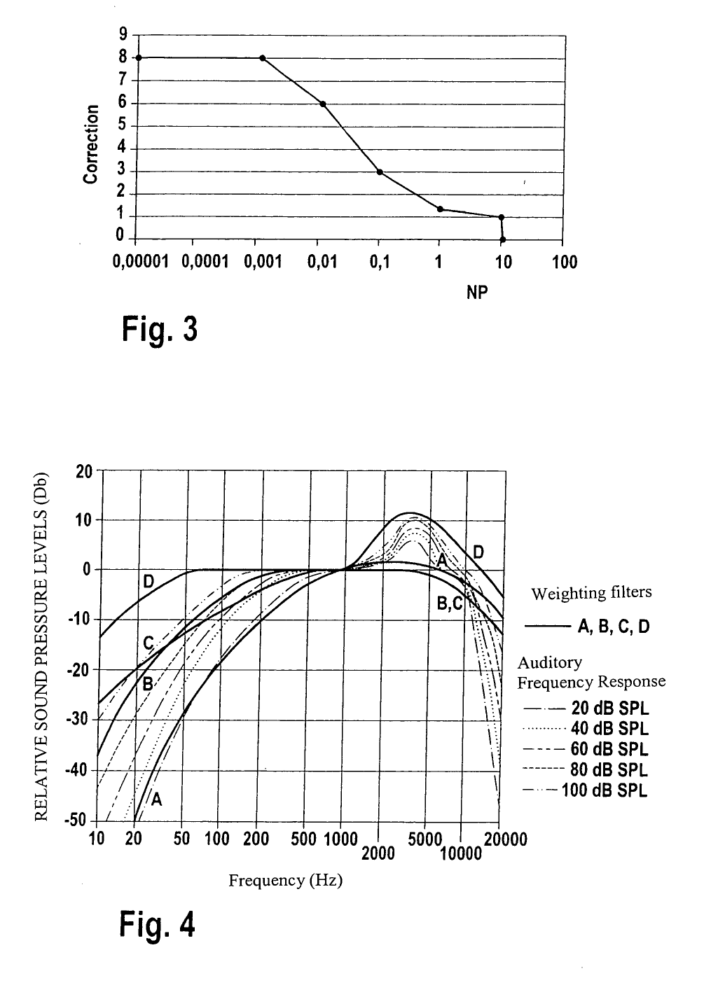

FIG. 3 shows how the correction term is ascertained. Variable NP, i.e., the ratio of braking operations subject to squeaking and the total number of braking operations in percent, is shown on the abscissa. A value of 100 means that squeaking noises occurred in all braking operations. The value of correction factor CORRECTION is plotted on the ordinate. Correction factor CORRECTION assumes values between 1 and 8 for 0≦NP≦10% in the example, and for NP<10% correction value CORRECTION=0.

The six interpolation points plotted as black dots in the diagram were obtained on the basis of experimental results in FIG. 3:

1) For NP=0.001, correction value CORRECTION=8
2) For NP=0.01, correction value CORRECTION=6
3) For NP=0.1, correction value CORRECTION=3
4) For NP=1, correction value CORRECTION=1.5
5) For NP=10, correction value CORRECTION=1
6) For values of NP>10, correction value CORRECTION=0.

For values in between, a linear interpolation may be used, for example, as shown here. Other curves are of course also possible for the correction value and other interpolation points and/or interpolation point values may also be determined.

The meaning of this correction term becomes plausible if one takes into account the fact that according to FIG. 1, the annoyance of the noise decreases for increasing values of bonisqueal. Very low values of NP in FIG. 3 mean that squeaking noises occur in only a very small fraction of braking operations. Therefore, a larger value CORRECTION is added to bonisqueal with each declining value of NP. This means that the annoyance of noises declines as the noises occur less frequently in a braking operation.

This correction term is added to variable bonisqueal, which has not yet been rounded to an integral or cut off at 1 or 10 and then the sum is rounded to integral values.

In addition, the sum
is set to 1, if it assumes a value of less than 1
is set to 10, if it assumes a value greater than 10.
   This integral value, which is cut off at 1 and 10 and is referred to as sessionbonisqueal, also represents an objective index that evaluates the annoyance of squeaking noises. This index is illustrated in FIG. 1.

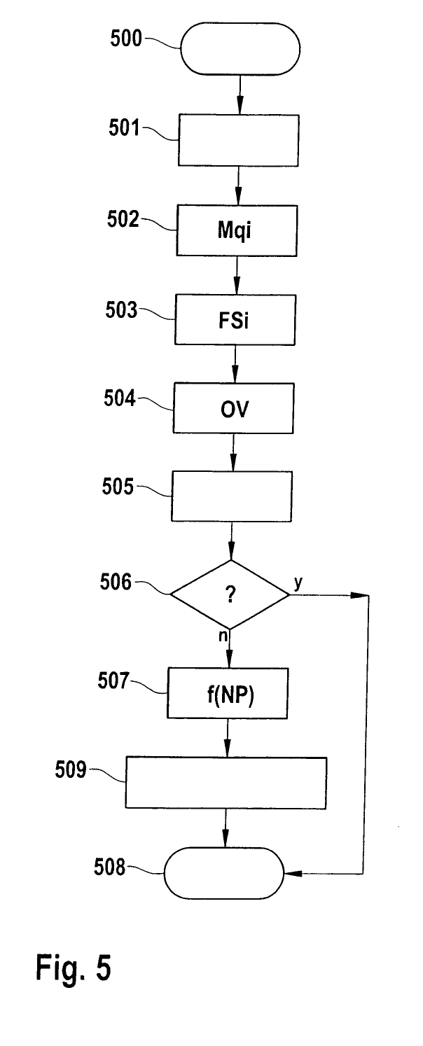

FIG. 5 illustrates the sequence of the method according to the present invention. After the start of the method in block 500, at least one braking operation is investigated in block 501 and analyzed with regard to the squeaking behavior. Next in block 502, each detected squeaking noise is evaluated with regard to six features Mq1, . . . , Mq6. For each feature, there is an individual evaluation number for each squeaking noise. Next in block 503, a feature evaluation number FSi is formed by linking the individual evaluation numbers formed for this feature for each squeaking noise. In block 504 a first intermediate variable OV is ascertained from feature evaluation numbers FSi by weighted addition. Next in block 505, variable bonisqueal is ascertained according to the given equation (1). This is a measure of the annoyance of the squeaking noises occurring during the braking operation. In block 506 a query is performed to determine whether the analysis should extend over only one braking operation. If the answer is “yes” (indicated as “y” in FIG. 5), i.e., only one braking operation is taken into account, the sequence jumps directly to the end of the method in block 508.

If the response is “no” (indicated as “n” in FIG. 5), i.e., several braking operations are considered, the following occurs in block 507
the average of the individual values of bonisqueal is ascertained, and
in addition, a term f(NP) is added which includes the number of performed braking operations subject to squeaking, based on the total number of braking operations, this ratio being referred to as NP.
   Variable sessionbonisqueal is ascertained from this in block 509; this is the total annoyance variable for the squeaking noises occurring during the braking operations. The method ends in block 508.

1-17. (canceled)

18. A method for evaluating an annoyance of at least one squeaking noise within a sound signal generated during operation of a motor vehicle or during operation of a component thereof, the method comprising:
detecting an existence of the at least one squeaking noise;
weighting at least one squeaking noise with regard to at least two predetermined features; and
ascertaining a variable characterizing the annoyance of the at least one squeaking noise from at least two evaluations of the at least one squeaking noise.

19. The method of claim 18, wherein the at least one squeaking noise includes a brake squeaking noise.

20. The method of claim 18, wherein the at least one squeaking noise is detected based on a detection of a maximum in an amplitude spectrum of the sound signal, and wherein the at least two features include at least one of:
a duration of the squeaking noise;
a maximum level of the weighed amplitude spectrum;
a maximum level of a weighted and smoothed spectrum obtained from the amplitude spectrum by weighting and smoothing;
a specific loudness of the signal;
a product of the duration of the squeaking signal and the maximal level of the weighted and smoothed spectrum;
a product of the duration of the squeaking signal and the maximal level of the weighted spectrum; and
a product of the duration and the specific loudness of the signal.

21. The method of claim 20, wherein an individual weighting number is ascertained for each of the at least two features for the at least one squeaking noise, and the variable characterizing the annoyance of the at least one squeaking noise is ascertained from the at least two ascertained individual evaluation numbers.

22. The method of claim 21, wherein the at least one squeaking noise is at least one brake squeaking noise occurring during a braking operation, wherein a feature evaluation number is formed for each of the at least two features by linking the individual evaluation numbers ascertained for the respective feature for each brake squeaking noise, and wherein an individual annoyance variable characterizing the annoyance of the squeaking noises occurring during the braking operation is ascertained from the at least two ascertained feature evaluation numbers.

23. The method of claim 22, wherein the linkage is a weighted addition.

24. The method of claim 22, wherein a first intermediate variable is ascertained from the at least two feature evaluation numbers by a weighted addition, and the individual annoyance variable is ascertained from the first intermediate variable.

25. The method of claim 24, wherein the individual annoyance variable is ascertained from the first intermediate variable according to the equation of:
$$bonisqueal = - \frac{b}{2} - \sqrt{\vert \frac{{b}^{2}}{4} - \frac{c - OV}{a} \vert} ,$$
where a, b and c are selectable parameters, OV is the first intermediate variable and bonisqueal is the individual annoyance variable.

26. The method of claim 25, wherein values a=0.016, b=−23.64375 and c=2.6327 are selected for the selectable parameters a, b and c.

27. The method of claim 25, wherein the individual annoyance variable is rounded to a next integral value, wherein the individual annoyance variable is set to a value of 1 if a value less than 1 is ascertained for the individual annoyance variable, and wherein the individual annoyance variable is set to a value of 10 if a value greater than 10 is ascertained for the individual annoyance variable.

28. The method of claim 25, wherein at least two braking operations are performed, a total annoyance variable characterizing the annoyance variable of the squeaking noises occurring during the braking operations is ascertained, and an average of the individual annoyance variables, which fulfill a predetermined condition and are ascertained for each braking operation, is included in the total annoyance variable.

29. The method of claim 28, wherein the predetermined condition is that the particular individual annoyance variable falls below a threshold value of 9.5.

30. The method of claim 29, wherein a term, which includes the number of performed braking operations subject to squeaking based on a total number of braking operations, is added to the total annoyance variable.

31. The method of claim 30, wherein the term is ascertained from the number of performed braking operations subject to squeaking based on the total number of braking operations using a predetermined characteristic curve.

32. The method of claim 31, wherein the characteristic curve is a monotonically descending characteristic curve.

33. The method of claim 28, wherein the total annoyance variable is rounded to the nearest integral value, and wherein the total annoyance variable is set to a value of 1, if a value of less than 1 is ascertained for the total annoyance variable, and wherein the total annoyance variable is set to a value of 10, if a value greater than 10 is ascertained for the total annoyance variable.

34. A device for evaluating an annoyance of at least one squeaking noise within a sound signal generated during operation of a motor vehicle or during operation of a component thereof, comprising:
a detecting arrangement to detect an existence of the at least one squeaking noise;
a weighting arrangement to weight at least one squeaking noise with regard to at least two predetermined features; and
an ascertaining arrangement to ascertain a variable characterizing the annoyance of the at least one squeaking noise from at least two evaluations of the at least one squeaking noise.
